(19) United States
(12) Patent Application Publication
(10) Pub. No.: US 2024/0294033 A1
(43) Pub. Date: Sep. 5, 2024

(54) METHOD FOR PRODUCING A PLASTIC ARTICLE, APPARATUS FOR CARRYING OUT SAID METHOD, AND PLASTIC ARTICLE

(71) Applicant: LEONHARD KURZ Stiftung & Co. KG, Fürth (DE)

(72) Inventors: Martin HAHN, Fürth (DE); Steven HIRSCHBERG, Fürth (DE)

(21) Appl. No.: 18/289,922

(22) PCT Filed: May 2, 2022
(86) PCT No.: PCT/EP2022/061714

§ 371 Date: Nov. 8, 2023

(30) Foreign Application Priority Data
May 12, 2021 (DE) 10 2021 112 416.6

(51) Int. Cl. B44C 3/00; B23K 26/00; B23K 26/0622; B23K 26/082; B23K 26/352; B23K 103/00; B41M 3/12; B41M 7/00; B44C 1/10; B44C 1/17; B44F 1/06

(52) U.S. Cl. CPC B44C 3/005; B23K 26/0006; B23K 26/082; B23K 26/352; B41M 3/12; B41M 7/0081; B44C 1/10; B44C 1/17; B23K 26/0622; B23K 2103/42; B44F 1/06

(57) ABSTRACT

A method for producing a plastic article including a) providing at least one film 10 having a carrier film and at least one decorative layer, b) forming, by means of lasers, at least one first area 21 and at least one second area 22 in the plane formed by the at least one film 10, wherein the at least one second area 22 has a higher transmittance than the at least first area 21, c) arranging at least one varnish layer 12 in the at least one second area 22 by means of digital printing, d) curing, the at least one film 10, and/or the at least one varnish layer 12, e) arranging the at least one film 10, on a substrate 11, f) obtaining a plastic article 1 comprising the at least one first area 21 and the at least one second area 22.

### CROSS-REFERENCE TO RELATED APPLICATIONS

This application is a National Stage application based on an International Application filed under the Patent Cooperation Treaty PCT/EP2022/061714, filed May 2, 2022, which claims priority to DE 102021112416.6, filed May 12, 2021.

### BACKGROUND OF THE INVENTION

The invention relates to a method for producing a plastic article, an apparatus for carrying out said method, and a plastic article.

To decorate surfaces, decorative films are often used, which are applied to a plastic article for example by means of in-mold methods. These surfaces are to be visually appealing and also to contain decorative elements, such as for example symbols or writing.

Such decorative elements are usually generated on the decorative film using printing technology. However, this results in a few disadvantages. Thus, both the positioning and the resolution of the decorative elements are limited by the printing method used. If in particular plastic articles decorated with individualized decorative films or correspondingly decorated plastic articles are to be produced in small quantities, this is associated with a large expenditure of time and logistical effort, and thus also with high costs, as the printing tools, such as for example printing plates, have to be provided and set up correspondingly for each individual decorative film. Alternatively, decorative elements, such as for example symbols or writing, can also be generated in the decorative film by means of laser engraving, wherein they are limited in their design possibilities, for example color.

DE 10 2018 123473 A1 relates to a decorative film, a transfer film, the use of a transfer film, a method for producing a transfer film, a method for decorating a plastic molded part and a plastic molded part.

EP 3 815 838 A1 a method for producing a transparent part for a vehicle.

EP 2 006 119 A2 relates to a method for manufacturing an inscribed plastic molded part, or a plastic molded part provided with similar markings, from an undeformed plastic film. It is further also concerned with a plastic molded part which is manufactured by deforming a plastic film provided with at least one color and/or cover layer.

DE 20 2019 106340 U1 relates to a plastic component part which is at least partially metalized, has imagery that can be shone through, and in particular is provided for use in a motor vehicle.

### SUMMARY OF THE INVENTION

The object of this invention is now to provide an improved method for producing a plastic article that can in particular be shone through, an improved apparatus for carrying out such a method, and an improved plastic article that can in particular be shone through.

This object is achieved with a method wherein the method comprises the following steps, which are carried out in particular in the following order:
a) providing at least one film comprising a carrier film and at least one decorative layer,
b) forming, by means of lasers, at least one first area and at least one second area in the plane formed by the at least one film, in particular by the decorative layer, wherein the at least one second area has a higher transmittance than the at least one first area,
c) arranging at least one varnish layer in the at least one second area by means of digital printing,
d) curing, in particular simultaneously curing, the at least one film, in particular the decorative layer, and/or the at least one varnish layer,
e) arranging the at least one film, in particular the decorative layer, on a substrate,
f) a plastic article comprising the at least one first area and the at least one second area is obtained.

By area is meant here in particular in each case a defined surface area of a layer, film, plane or ply which is occupied when viewed perpendicular to a plane formed by the film, in particular by the at least one decorative layer, the varnish layer and/or the substrate. Thus, for example, the at least one substrate has at least one first area and an at least second area, wherein each of the two or more areas in each case occupies a defined surface area when viewed perpendicular to a plane formed by the substrate, in particular in all layers arranged on top of and/or underneath the substrate.

By the expressions underneath and/or on top of is meant here in particular the arrangement of layers in relation to another layer when viewed by an observer from an observation direction. Thus, it is expedient if the expressions underneath and/or on top of represent a frame of reference. The observation direction is preferably chosen such that a film and/or layer which forms the visible face of the plastic article is arranged on top of other films and/or layers.

Through the invention, an advantageous combination of transfer varnish methods, in particular of hot-stamping methods and/or in-mold decoration (IMD) methods, and/or laminating methods, in particular in-mold labeling (IML) methods, insert molding methods and/or print mold design (PMD) methods, with laser methods and digital printing methods can be made possible.

The transfer varnish technology has the advantage that the overall thickness of the decorative layer can be produced much thinner compared with other decoration methods, such as for example varnishing or direct screen printing. A lower height difference between decorative layer and the area in which the decorative layer has been removed thus also forms when this removal of the decorative layer is effected by means of lasers.

This makes a much simpler, more material-saving and more waste-reducing printing of the selected area possible. As a result, the carbon footprint can be significantly improved by this combination and thus the energy costs can also be reduced.

Further, laser technology in direct combination with digital printing methods further provides a very flexible and variable manufacturing platform. As both technologies are digitally controlled, design variations, such as shape, position and color of the second area, can thus be individually integrated in the method. Thus, it is further possible to use the whole color spectrum which can be implemented in digital printing also in this method. Multicolored areas are thus also conceivable, for example.

Further, by means of this invention it is advantageously possible to give the decorative layer that is preferably arranged on a substrate a 3D contour by means of forming technologies, such as for example vacuum forming or high pressure forming. In particular here a laser machining with integrated digital printing can also be carried out only after the deforming, which further increases the flexibility and sets the method according to the invention further apart from pure transfer varnish methods.

A trend of manufacturing different embodiment variants of a product is currently to be observed in many sectors of industry. Thus, it may be the case that a decoration is to be designed with different languages or colors in different countries. The present invention makes it possible to react to the above-named trend and to create the decoration as required. A personalized batch size of one is even possible here.

This further also leads to a reduction in delivery times, but at the same time also enables a higher flexibility in response to peaks and troughs in product demand. Furthermore, logistical work and the costs thereof are much further reduced as the variants can be generated as required in the production process and no longer for stock storage. In other words, the end customer can decide how, for example, a panel of a washing machine is to be designed and has an unlimited choice of color of the symbols introduced into the decorative layer.

Further advantageous designs of the invention are described in the dependent claims.

It has proved to be advantageous that the at least one film, in particular decorative layer, provided in step a) is preferably provided as a transfer film, in particular comprising a carrier film and a transfer ply detachable from the carrier film, or a laminating film, or is designed as a film of this type. In other words, it is possible for the carrier film to be peeled off during the method, in particular before, during or after step e).

Preferably, the at least one film, in particular the decorative layer, is a layer with components, in particular binders, selected individually or in combination from: monomers, oligomers, polymers, copolymers, preferably comprising, is selected individually or in combination from: polymethyl methacrylates, polyesters, polyacrylates, polycarbonates, polyamides, polyurethanes, polyvinyl chloride (PVC), phenols, isocyanate-group-containing polymers, epoxide-group-containing polymers, melamine-containing polymers, hydroxyl-group-containing polymers, further preferably comprising polyurethanes and/or PVC.

In order to additionally achieve an advantageous overprintability of the decorative layer, the decorative layer has in particular a receiving layer, which contains at least one water-dispersible polymer, which is selected in each case independently of one another from the group which consists of polyurethanes, polyacrylates, polymethacrylates, polyesters, copolymers thereof and mixtures thereof, preferably selected from polyurethanes, polyurethane/polyacrylate copolymers, polyacrylates and/or polymethacrylates, polyesters and mixtures thereof, wherein the at least one water-dispersible polymer is preferably a polyurethane-containing polymer, which is preferably selected from the group which consists of polyurethanes, polyurethane/poly(meth)acrylate copolymers and mixtures thereof.

In order to additionally achieve a sufficiently high resistance of the decorative layer to chemical and/or physical influences, the decorative layer has at least one protective layer, which is in particular produced based on at least one UV-crosslinkable and/or chemically crosslinkable polymer. For this it is further possible for the at least one protective layer furthermore to contain at least one chemically crosslinkable polymer, which is further preferably selected from the group which consists of isocyanate-group-containing polymers, melamine-containing polymers, hydroxyl-group-containing polymers and mixtures thereof. The at least one protective layer preferably has at least one chemically crosslinkable polymer combination, which comprises or is a polymer and/or copolymer with at least one, preferably two or more, isocyanate group(s) and at least one polymer and/or copolymer with at least one, preferably two or more, hydroxyl group(s) and/or at least one melamine resin and at least one polymer and/or copolymer with at least one, preferably two or more, hydroxyl group(s).

It is further possible for the at least one UV-crosslinkable polymer of the at least one protective layer and/or the receiving layer furthermore to have, in each case independently of one another, at least one chemically crosslinkable functional group, wherein the chemically crosslinkable functional group is preferably selected from hydroxyl group, isocyanate group, melamine group, epoxide group and combinations thereof.

Preferably, the at least one UV-crosslinkable polymer furthermore has at least one hydroxyl group.

Suitable UV-crosslinkable hydroxyl-group-containing polymers are known from the state of the art and comprise for example at least one diacrylate monomer, aliphatic polyether urethane diacrylate, aliphatic polyester urethane diacrylate, aromatic polyether urethane diacrylate, aromatic polyester urethane diacrylate, polyester diacrylate, polyether diacrylate, epoxy diacrylate, acrylated acrylic diacrylate, polyacrylate monomer, aliphatic polyether urethane polyacrylate, aliphatic polyester urethane polyacrylate, aromatic polyether urethane polyacrylate, aromatic polyester urethane polyacrylate, polyester polyacrylate, polyether polyacrylate, epoxy polyacrylate, acrylated acrylic polyacrylate or mixtures thereof and/or at least one hydroxy monoacrylate, hydroxy diacrylate, hydroxy polyacrylate, hydroxy-functionalized aliphatic polyether urethane monoacrylate, hydroxy-functionalized aliphatic polyester urethane monoacrylate, hydroxy-functionalized aromatic polyether urethane monoacrylate, hydroxy-functionalized aromatic polyester urethane monoacrylate, hydroxy-functionalized polyester monoacrylate, hydroxy-functionalized polyether monoacrylate, hydroxy-functionalized epoxy monoacrylate, hydroxy-functionalized acrylated acrylic monoacrylate, hydroxy-functionalized aliphatic polyether urethane diacrylate, hydroxy-functionalized aliphatic polyester urethane diacrylate, hydroxy-functionalized aromatic polyether urethane diacrylate, hydroxy-functionalized aromatic polyester urethane diacrylate, hydroxy-functionalized polyester diacrylate, hydroxy-functionalized polyether diacrylate, hydroxy-functionalized epoxy diacrylate, hydroxy-functionalized acrylated acrylic diacrylate, hydroxy-functionalized aliphatic polyether urethane polyacrylate, hydroxy-functionalized aliphatic polyester urethane polyacrylate, hydroxy-functionalized aromatic polyether urethane polyacrylate, hydroxy-functionalized aromatic polyester urethane polyacrylate, hydroxy-functionalized polyester polyacrylate, hydroxy-functionalized polyether polyacrylate, hydroxy-functionalized epoxy polyacrylate, hydroxy-functionalized acrylated acrylate or mixtures thereof.

As melamine resins, those which can be obtained by reacting melamine with aldehydes and optionally can be partially or completely modified are suitable in particular.

In particular, formaldehyde, acetaldehyde, isobutyraldehyde and glyoxal are suitable as aldehydes.

Melamine formaldehyde resins are preferably reaction products of the reaction of melamine with aldehydes, for example the above-named aldehydes, in particular formaldehyde. The methylol groups obtained are preferably modified by etherification with mono- or polyhydric alcohols.

Further, it is possible for the at least one protective layer to have precured systems and/or hybrid systems. It is possible in particular for the at least one protective layer to have at least one UV-curable component consisting of UV-curable monomers and/or UV-curable oligomers or mixtures thereof and furthermore to have at least one binder, which is selected from the group which consists of polyurethanes, polyacrylates, polymethacrylates, polyester resins, polycarbonates, phenolic resins, epoxy resins, polyureas, melamine resins, preferably polymethyl methacrylate (PMMA), polyester, polycarbonate (PC) and mixtures thereof.

It is further possible for the at least one protective layer preferably to comprise at least one polyisocyanate. The term “polyisocyanate” preferably describes an organic compound with two or more isocyanate groups, including triisocyanates and higher-functional isocyanates. In particular embodiments, the at least one polyisocyanate is selected from the group which consists of diisocyanate monomer, diisocyanate oligomer, diisocyanate-terminated prepolymer, diisocyanate-terminated polymer, polyisocyanate monomer, polyisocyanate oligomer, polyisocyanate-terminated prepolymer, polyisocyanate-terminated polymer, polyisocyanate-terminated polymer and mixtures thereof.

Further preferably, the at least one polyisocyanate comprises or is at least one diisocyanate-containing component, which preferably contains at least one diisocyanate-containing polyurethane oligomer, diisocyanate-containing polyurea oligomer, prepolymers thereof, polymers thereof or mixtures thereof.

In particular embodiments, the at least one polyisocyanate comprises or is at least one diisocyanate-containing component, which is preferably selected from the group which consists of hexamethylene diisocyanate (HDI), isophorone diisocyanate (IPDI), methylene diphenyl diisocyanate (MDI), toluene diisocyanate (TDI), phenylene diisocyanate, naphthalene diisocyanate, diphenyl sulfone diisocyanate, ethylene diisocyanate, propylene diisocyanate, dimers of these diisocyanates, trimers of these diisocyanates, triphenylmethane triisocyanate, polyphenylmethane polyisocyanate (polymeric MDI) and mixtures thereof.

It can further be advantageous if the at least one film, in particular the decorative layer, has layers, in particular has in each case at least one or more of the following layers, in each case selected individually or in combination from: at least one colored varnish layer, at least one metal layer, at least one adhesive layer, at least one adhesion-promoter layer, at least one barrier layer, at least one receiving layer, at least one protective varnish layer, at least one detachment layer, at least one replication layer, at least one laser protective varnish layer.

It is further advantageous if the at least one decorative layer forms the transfer ply and is detachable from the carrier film.

Such a design increases the possibilities of individualization, the optical value and/or the possible uses still further. The film can also have multilayered colored varnish systems, in which one or more layers are stripped off by means of laser and the underlying layer thus becomes visible. Individual designs can be realized hereby. The at least one film, in particular the decorative layer, preferably has a layer thickness selected from a range of from 0.1 μm to 50 μm, preferably from 0.5 μm to 35 μm, preferably from 1 μm to 5 μm.

The at least one film, in particular the decorative layer, can further have a metalization, in particular with a layer thickness of from 1 nm to 20 μm, preferably from 5 nm to 15 μm. The metalization is preferably formed of metals and/or metal combinations and/or alloys selected individually or in combination from: aluminum, copper, cobalt, gold, indium, iron, chromium, nickel, silver, platinum, palladium, titanium.

It is possible for the at least one film, in particular the decorative layer, to have been and/or to be arranged on the substrate over the whole surface in step e). The optical properties of the finished product are hereby independently of the optical properties of the substrate and the possible designs of the finished product are thus increased.

Alternatively, in step e) the at least one film, in particular the decorative layer, can be or have been arranged on the substrate only in areas, wherein in particular the substrate is visible to an observer, in particular in the viewing direction onto the side of the substrate facing the decorative layer. For example, it is possible for the decorative layer not to be or not to have been arranged in edge areas or areas in the center of the substrate. This is advantageous if these areas are not visible in the finished product and/or it is desired that the optical properties of the substrate remain recognizable. It is also possible for other layers or layer packets to be arranged on the substrate in the areas in which the decorative layer is not arranged. It is also possible for no layers to be arranged on the substrate in the areas in which the decorative layer is not arranged, i.e. for the substrate to be uncoated in these areas.

It is advantageous in particular if the at least one film, in particular the decorative layer, is formed opaque and/or if the at least one film, in particular the decorative layer, has a transmittance, i.e. a permeability for electromagnetic waves, in particular in the wavelength range of from 380 nm to 780 nm, of at most 50%, preferably of at most 20%, further preferably of at most 5%.

It is hereby achieved that the at least one film, in particular the decorative layer, generates an optically dark impression, in particular wherein the optical impression provides a background that appears dark with respect to a possible backlighting. In particular, a particularly high contrast between the backlighting and this background can thereby be achieved and the backlighting can be perceived sufficiently well even at low backlighting luminous intensities.

The transmittance is in particular determined using a spectrophotometer, for example of the U-2000 type, Hitachi Ltd. Corp., Japan, preferably in a wavelength range between 380 nm and 780 nm.

It is possible for the at least one film, in particular the decorative layer, to be arranged in step e) using a transfer varnish method, in particular a hot-stamping method and/or an IMD method, and/or using a laminating method, in particular an IML method, an insert molding method and/or a PMD method.

It is further possible for the at least one film, in particular the decorative layer, to be and/or to have been arranged on the substrate in such a way that the decorative layer faces an observer.

It is also possible for the at least one film, in particular the decorative layer, to be and/or to have been arranged on the side of the substrate facing away from the observer. It is hereby possible for the substrate to protect the decorative layer from external, in particular physical and/or chemical, influences and/or loads.

It is thus possible for the at least one film, in particular the decorative layer, to have been arranged underneath and/or on top of the substrate. The at least one film, in particular the decorative layer, is preferably arranged on the substrate in such a way that it is firmly joined to the substrate.

By the term firmly joined is preferably meant here a durable join of two elements, with the result that they can no longer be separated mechanically without damaging at least one of the elements.

In step b) the film, in particular the decorative layer, is irradiated by means of lasers in such a way that at least one first and one second area are formed, wherein the at least second area has a higher transmittance. In particular it is advantageous if in step b) the at least one film, in particular the decorative layer, is and/or has been removed, preferably completely removed, in the at least one second area.

It is also possible for the at least one second area to be formed in such a way that at least one of the layers of the decorative layer is removed. In particular, it is possible for the at least one second area to be formed in such a way that at least one of the layers of the decorative layer, preferably at least one colored varnish layer, is not removed, preferably not completely removed, in the at least one second area. It is thus possible for at least one colored varnish layer to be arranged in the at least one second area in particular after step b).

By removal of a layer is meant here the partial and/or complete removal of a layer, in particular by means of laser cutting and/or laser ablation. If, for example, a layer is removed in an area, the corresponding layer in this area has been partially and/or completely removed. The removal is preferably effected here by virtue of laser cutting and/or laser ablation.

By partially removed is preferably meant here that the partially removed layer is altered or destroyed in such a way that it no longer satisfies its predetermined properties. Thus, for example, a partially removed protective varnish layer no longer satisfies its predetermined property of protecting layers arranged underneath from chemical, physical and/or mechanical environmental influences.

By completely removed is preferably meant here that the completely removed layers are stripped off and/or ablated and/or burnt up and/or evaporated residue-free in the corresponding areas. Thus, if for example the at least one decorative layer is completely removed in the at least one second area, in particular by means of laser cutting and/or laser ablation, then the at least one decorative layer is stripped off residue-free in the at least second area.

Advantageously, the difference in the transmittance between the at least one first area and the at least one second area of the plastic article after step f) is preferably at least 5%, preferably at least 10%, particularly preferably at least 25%, in particular in the wavelength range of from 380 nm to 780 nm. The at least one second area in the plastic article preferably has a higher transmittance than the at least one first area. This ensures that there is a sufficient contrast in transmitted light, with the result that a sharp and easily recognizable decoration forms.

In particular, at least one second area is and/or has been designed in the shape of or comprises a symbol, a geometric figure, a pattern, an alphanumeric character and/or a logo. These shapes can also be combined with abstract graphic design elements. The design of the at least one second area can have a purely ornamental function, but preferably also be functional and, for example, mark display or operating elements of a device, such as status indicators, operating areas or the like.

It is further preferred if the at least one second area, when viewed perpendicular to the at least one film, in particular decorative layer, has a line width of at least 50 μm, preferably of at least 100 μm, and/or if the at least one second area, when viewed perpendicular to the at least one film, in particular decorative layer, has a line width of at most 2 mm, preferably of at most 1 mm, further preferably of at most 0.5 mm.

The minimum line width is determined by the resolution capacity and perceptive capacity of the human eye. Through a possible backlighting or in transmitted light, extremely fine lines are also still recognizable.

Advantageously, in step c) the at least one varnish layer is and/or has been arranged in contact with the at least one film, in particular the decorative layer, and/or on the side of the substrate facing away from the film, in particular the decorative layer. For example, the at least one varnish layer can be arranged in the area of the film, in particular decorative layer, in which in step b) it was removed, in particular completely removed, by irradiation by means of lasers.

It is possible for the varnish layer, in the at least one second area, in particular if in the at least one second area at least one of the layers of the decorative layer is removed and/or at least one of the layers of the decorative layer, preferably at least one colored varnish layer, is not removed, preferably not completely removed, to overlap at least one of the layers of the decorative layer, preferably at least one colored varnish layer, over part of the surface or over the whole surface.

In other words, the at least one varnish layer can be arranged on top of and/or underneath the substrate, preferably on one of the surfaces of the substrate.

Arranging the at least one varnish layer on top of the substrate has the advantage in particular that the optical properties of the varnish can appear particularly brilliant. Arranging the at least one varnish layer underneath the substrate makes it possible, for example, to print several second areas next to one another more easily compared with arranging the at least one varnish layer on top of the substrate. That is to say, here only lower tolerances need to be adhered to since the second areas act like optical masks in the case of observation onto the plane spanned by the substrate and mask, i.e. optically conceal, the visible edges of the at least one varnish layer. The quantity of waste can thereby also be reduced.

The at least one varnish layer preferably has components, which can be cured by exposure to thermal and/or high-energy radiation, preferably UV radiation, in particular with a wavelength in the range of from 200 nm to 280 nm. Expediently, the at least one varnish layer is has of components, in particular binders, selected individually or in combination from: polyethylene terephthalate (PET), polymethyl methacrylates, polyesters, polyacrylates, polycarbonates, polyethylene naphthalate (PEN), polyamides, acrylonitrile-butadiene-styrene copolymer (ABS), phenols, isocyanate-group-containing polymers, epoxide-group-containing polymers, melamine-containing polymers, hydroxyl-group-containing polymers.

It is also possible for the at least one varnish layer to be dyed, in particular for the at least one varnish layer to be dyed by means of dyes and/or color pigments. Preferably, the pigmentation level of the at least one varnish layer is less than 15%, preferably less than 10%, further preferably less than 5%. In particular, this makes it possible for the at least one varnish layer in conjunction with backlighting means arranged underneath the varnish layer, to generate a specific optical impression, such as for example a colored translucent impression when a white light source is used as backlighting means.

However, it is also possible for the at least one varnish layer to be colorless and/or to be clearly transparent and/or for the pigmentation level of the varnish layer to be 0%. The resulting colored impression is determined here, for example, by a backlighting means arranged underneath the varnish layer and the light color thereof.

The at least one second area and/or the at least one varnish layer is advantageously formed transparent and/or the at least one second area and/or the at least one varnish layer have a transmittance, in particular in the wavelength range of from 380 nm to 780 nm, of at least 5%, preferably of at least 25%, further preferably of at least 75%.

In at least one second area, the at least one varnish layer can be arranged in one layer. It is further possible for the at least one varnish layer to be formed of two or more partial layers, in particular wherein the partial layers have the same chemical and physical properties. In particular, through the arrangement of partial layers, the quality of the application can be improved in the case of subsurfaces which for example do not have a homogeneous structure and/or other nature.

It is further possible for the at least one varnish layer to be and/or to have been arranged multilayered, in particular for the at least one varnish layer to be and/or to have been formed from two or more partial layers, wherein the two or more partial layers are preferably arranged in each case with a layer thickness in the range of from 0.1 μm to 50 μm, further preferably of from 0.5 μm to 5.0 μm.

It further makes sense if the two or more partial layers have different colors, in particular from the RGB color space or the CMYK color space.

By color or chromaticity or single color or single chromaticity is meant a color location in a color space. The color space can be in particular the CIELAB color space. The color space can also be the RGB color space (R=red; G=green; B=blue) or the CMYK color space (C=cyan; M=magenta; Y=yellow; K=black) or color spaces such as RAL, HKS or the Pantone® color space.

By a different or differing chromaticity is meant a color difference dE between two color locations in a color space. The color space can be in particular the CIELAB color space. A different chromaticity that is sufficiently easily perceptible for the human eye has a color difference dE in the CIELAB color space of at least 2, preferably of at least 3, particularly preferably of at least 5, further preferably of at least 10.

The color location, in particular in the CIELAB color space, is usually determined with a colorimeter, for example with a “Datacolor 650” spectrophotometer.

The value of dE (or also Delta E or ΔE) between the color locations (L*, a*, b*)ₚ and (L*, a*, b*)ᵥ is calculated as a Euclidean distance:

$${dE}_{p , v} = \sqrt{{( {L}_{p}^{*} - {L}_{v}^{*} )}^{2} + {( {a}_{p}^{*} - {a}_{v}^{*} )}^{2} + {( {b}_{p}^{*} - {b}_{v}^{*} )}^{2}}$$

Here, the lightness value L* is perpendicular to the color plane (a*, b*). The a-coordinate indicates the chroma and color intensity between green and red and the b-coordinate indicates the chroma and the color intensity between blue and yellow. The larger the positive a and b values and the smaller the negative a and b values, the more intense the color shade. If a=0 and b=0, there is an achromatic color shade on the lightness axis. Usually, L* can adopt values between 0 and 100 and a and b can vary between −128 and +127.

It is further conceivable that one of the colors of the partial layers of the at least one varnish layer is and/or has been arranged in areas, in particular that one of the colors is present in at least one first subarea and is not present in at least one second subarea and/or that the partial layers are and/or have been arranged in a grid, in particular selected from: frequency-modulated grid, amplitude-modulated grid, random grid, pseudo-random grid.

It is also possible for at least two differing varnish layers to be arranged in at least one of the second areas in step c), wherein the at least two varnish layers differ in particular in their optical properties, such as for example color and/or optical density and/or transmittance.

The preceding designs provide the advantage that, with a possible backlighting of the plastic article, single-colored but also multicolored patterns and/or motifs can be generated with only one backlighting means.

However, it is also possible for no varnish layer to be and/or to have been arranged in at least one of the second areas. In this area, the substrate thus preferably forms the layer facing the observer. For example, with backlighting of the plastic article, the optical properties of the substrate and/or of a backlighting means are visible here.

It is further possible for the optical density of an at least second area and/or at least one varnish layer, in particular in the case of a surface area completely covered with a single color shade, and/or of a subarea of at least one second area, to be selected from a range of from 0.5 to 3, preferably from 0.8 to 2.5 have.

The values of the optical density (OD) are measured, for example, using a densitometer “name” from [X-Rite GmbH], [82152 Planegg-Martinsried], Germany. During the measurement of the optical density, a precisely defined directed white light beam is directed, for example, onto the surface of a colored varnish layer arranged on a substrate. The measuring light beam penetrates the colored varnish layer and is reflected at the boundary surface between colored varnish layer and substrate. The reflected light penetrates the colored varnish layer once again and is detected by a photoelement, wherein an electrical signal that is proportional to the luminous intensity is generated. During the double penetration of the colored varnish layer, the preferably originally white measuring light is colored and weakened in particular by absorption. This yields the remission value (R), which is preferably calibrated, using a standard, advantageously to R=1 (=100%). The highest achievable remission value is thus preferably R=1. The measured remission value is therefore preferably a value from a range of from 0 to 1, wherein the remission values in particular represent unitless values.

The value of the optical density (OD) can then be calculated from the remission value (R) according to the following equation: OD=Ig(1/R)

According to the above equation, high remission values yield low values of optical density, and vice versa. The optical density of the substrate with a preferred remission value where R=1 is preferably OD=0. With the increase in the applied quantity of ink, preferably layer thickness or pigmentation level, the remission falls and the optical density increases.

In particular, instead of the remission, the transmittance of a colored varnish layer can also be used in order to calculate the optical density. The functional relationship between transmittance (T) in percent (%) and optical density (OD) is formulated as follows: OD=Ig(100/T[%]).

The at least one varnish layer can be and/or have been arranged substantially only in the at least second area and not in the at least one first area. Alternatively, it is also possible for the at least one varnish layer arranged in at least one of the second areas to be or have been arranged overlapping the at least one first area in areas in step c), in particular if the at least one varnish layer, in observation onto the visible surface of the plastic article, is arranged underneath the substrate or underneath the side of the substrate and/or the film, in particular the decorative layer, facing away from an observer.

In other words, the at least one varnish layer can be and/or have been arranged in particular in the first areas in contact with the edge areas of the at least one second area, wherein at least one second area is arranged in each of the printed surface area, preferably in the center.

This is helpful in particular when several second areas lie close to one another, with the result that the arrangement of the varnish layer can be accelerated due to a two-dimensional arrangement of the at least one varnish layer over the second areas. It is further advantageous that lower tolerances need to be adhered to in the case of such an application of the varnish layer. This is because the second area introduced into the at least one film, in particular decorative layer, using the laser here acts like a mask.

It is also possible for a primer to be and/or have been arranged in the at least one second area before the at least one varnish layer is arranged. In particular, the primer is arranged between the substrate and/or the at least one film, in particular the decorative layer, and the at least one varnish layer.

The primer preferably has a transmittance, in particular in the wavelength range of from 380 nm to 780 nm, of at least 10%, preferably of at least 25%, further preferably of at least 75%, still further preferably of at least 90%. It is also possible for the primer to be dyed, preferably to be dyed white, in particular for the primer to be dyed by means of dyes and/or color pigments. Preferably, the pigmentation level of the primer is less than 15%, preferably less than 10%, further preferably less than 5%.

However, it is also possible for the primer to be colorless and/or to be clearly transparent and/or for the pigmentation level of the primer to be 0%.

The primer is preferably arranged with a layer thickness selected from the range of from 0.1 μm to 10 μm, preferably from 0.3 μm to 5 μm, or has this layer thickness.

Through a primer, the adhesion of the at least one varnish layer to the subsurface to be printed on is improved and/or unevennesses are leveled out and/or color quality and color brilliance of the at least one varnish layer is improved.

It is possible for the at least one varnish layer to be arranged register-accurately and/or registration-accurately.

By register or registration, or register accuracy or registration accuracy, is meant a positional accuracy of two or more elements, films, planes, areas and/or layers relative to each other. The register accuracy is to range within a predefined tolerance which is to be as small as possible. At the same time, the register accuracy of several elements, films, planes, areas and/or layers relative to one another is an important feature in order to increase the process reliability.

The positionally accurate positioning can be effected in particular by means of sensory, preferably optically detectable registration marks or register marks, optical sensor units, preferably cameras, stencils, masks and/or mechanical limit stops. In particular, registration marks or register marks can either represent specific separate elements or areas or layers or themselves be part of the elements or areas or layers to be positioned.

The at least one varnish layer, which is arranged in such a way that it is arranged on top of the substrate on the side of the plastic article facing the observer, and/or is at least partially in contact with the at least one decorative layer, is preferably arranged with a tolerance of at most ±0.7 mm, preferably of at most ±0.5 mm, further preferably of at most ±0.3 mm, with respect to a target position or has the above tolerance with respect to a target position. The at least one varnish layer, which is arranged on the side of the substrate facing away from the at least one decorative layer, is preferably arranged with a tolerance of at most ±5 mm, preferably of at most ±1 mm, further preferably of at most ±0.5 mm, with respect to a target position and/or has the above tolerance with respect to a target position.

It is possible for the at least one varnish layer to be arranged inline and/or downstream in step c). In other words, the method steps can be carried out directly one after another and/or the arrangement of the at least one varnish layer is not effected until after the at least one film, in particular the decorative layer, has been, for example, temporarily stored, transported and/or removed from the apparatus provided for the method.

Advantageously, for carrying out the method for the arrangement of the at least one varnish layer, a varnish is used which has a surface energy during step c) preferably selected from a range of from 15 mN/m to 45 mN/m, preferably from 20 mN/m to mN/m.

It is further advantageous if the surface energy of the at least one film, in particular the decorative layer, and/or of the substrate during step c) is selected from a range of from 30 mN/m to 50 mN/m, preferably from 30 mN/m to 45 mN/m.

In step c), the difference between the surface tension of the varnish of the at least one varnish layer and the at least one film, in particular the decorative layer, and/or the substrate is preferably at least a value selected from a range of from ±5 mN/m to ±100 mN/m, preferably from ±10 mN/m to ±70 mN/m and at most a value selected from a range of from ±15 mN/m to ±50 mN/m, preferably from ±20 mN/m to ±35 mN/m.

The at least one film, in particular the decorative layer, and/or the substrate preferably has, during step c), a larger surface energy compared with the varnish to be deposited of the at least one varnish layer.

By surface energy is meant the energy which must at a minimum be applied to break the molecular bonds of the surfaces of liquids and/or solids. In other words, the surface energy is the force which is required in order to enlarge the surface of a liquid and/or a solid.

If the varnish, the at least one film, and/or the substrate has the above values for surface energy, it can be ensured that on the one hand the varnish sufficiently wets the at least one film and/or the substrate, but on the other hand the drops of the varnish do not completely run or even spread. Thus, the drops of the varnish adhere to the printed surface with a defined geometry without running. This makes a particularly sharp detail edge possible during printing.

In the at least one second area the at least one varnish layer is preferably arranged with a layer thickness selected from a range of from 2 μm to 36 μm, preferably from 4 μm to 18 μm, preferably from 5 μm to 12 μm.

The substrate is preferably formed single-layered or multilayered from thermoplastic materials selected individually or in combination from PC, PET, PMMA, PEN, PA, ABS. The thermoplastic nature of the named materials makes a problem-free forming possible.

The substrate is advantageously formed transparent or semitransparent and/or the substrate has a transmittance, in particular in the wavelength range of from 380 nm to 780 nm, of at least 10%, preferably of at least 25%, further preferably of at least 75%, still further preferably of at least 90%.

As a result, the substrate can be shone through, in particular can be shone through by means of a backlighting means and/or the at least one film, in particular the decorative layer, is visible when it is attached underneath the substrate in the observation direction.

The preceding design of the substrate is also advantageous if the at least one film, in particular the decorative layer, has been and/or is arranged on the side of the substrate facing away from the observer, since here the decorative layer is protected from external, in particular chemical and/or physical, loads on the one hand and on the other hand is still perceived by the observer.

The substrate preferably has a layer thickness selected from a range of from 0.25 mm to 20 mm, in particular from 1 mm to 5 mm. This ensures the production of a thin and optionally flexible plastic article.

Advantageously, the at least one laser used during the method in step b) and/or present in the apparatus is preferably selected from: solid-state laser, preferably fiber laser, YAG laser, UV laser, ruby laser and/or sapphire laser, diode laser, gas laser and/or dye laser.

It is also advantageous that the at least one laser preferably emits coherent light from the infrared range, in particular from the near infrared range, further preferably from the wavelength range of from 200 nm to 1400 nm, preferably from 780 nm to 1200 nm, further preferably light with a wavelength of 1064 nm. Alternatively, a laser can also be used which in particular emits light from the UV range, further preferably with a wavelength of from 340 nm to 400 nm, further preferably light with a wavelength of 355 nm. The laser can further be operated continuously or pulsed.

It is further also possible for the at least one laser to be used with a beam diameter at the focal point of at least 30 μm, preferably at least 50 μm, preferably at least 100 μm, in step b).

It is also possible to focus the laser beam by means of at least one lens, in particular with a focal length in a range of from 100 mm to 500 mm, preferably from 150 mm to 300 mm, further preferably of 163 mm or 254 mm.

It is expedient if the laser beam is deflected by means of movable mirrors, in particular by means of a laser scanning module, along the at least one second area in step b).

The laser beam can in particular be controlled with a tolerance of at most ±0.5 mm, preferably of at most ±0.3 mm, further preferably of at most ±0.1 mm, with respect to a target position or the second area thus generated by means of lasers has a tolerance of at most ±0.5 mm, preferably of at most ±0.3 mm, further preferably of at most ±0.1 mm, with respect to a target position.

The at least one laser preferably has a power selected from a range of from 0.05 W to 100 W, preferably from 1 W to 50 W, further preferably from 5 W to 20 W. In particular, the at least one laser is operated with a writing speed of at most 10,000 mm/s, preferably with a writing speed selected from a range of from 500 m/s to 2500 mm/s.

The at least one laser is further operated in particular with a pulse frequency selected from a range of from 1 Hz to 1000 kHz, preferably from 25 kHz and 400 kHz, and/or the at least one laser is operated with up to 3000 characters/s, preferably selected from a range of from 800 characters/s to 1500 characters/s. The required intensity of the laser beam conforms to the type and thickness of the at least one film, in particular the decorative layer, and to the speed with which the at least one film, in particular the decorative layer, is to be removed.

It is also possible for the at least one film, in particular the decorative layer, to be able to be overprinted and for the method further to comprise the following step, in particular which is carried out before step d) and/or before and/or after step c):
g) printing on the at least one film, in particular the decorative layer, by means of digital printing, in particular with a primer and/or with at least one varnish layer, preferably comprising a haptic varnish, wherein at least one third area is formed, and wherein the at least one third area does not overlap the at least one second area.

The possible designs of a product manufactured using this method can hereby be still further increased.

For a design of the at least one third area it is preferably possible to fall back on the mentioned design variants of the at least one second area, in particular with regard to the printing methods and/or printing parameters and/or printing apparatus.

Alternatively or additionally, the at least one third area can be formed opaque and/or have a remission, in particular in the wavelength range of from 380 nm to 780 nm, of at most 0.5, preferably of at most 0.2, further preferably of at most 0.05.

For example, when the same printhead is used, the advantage is provided that step g) can be carried out inline and without additional costs for additional printing apparatuses. Alternatively, step g) can also be carried out downstream. In particular, it is advantageous to arrange the at least one third area where no backlighting means are attached. The at least one first area and the at least one third area preferably overlap at least in areas and/or completely.

In step c) and/or step g) one of the following digital printing methods is preferably used, in particular for the arrangement of the at least one varnish layer: inkjet, in particular continuous inkjet and/or piezoelectric inkjet and/or thermoelectric inkjet (bubble jet), and/or thermal printing.

In step c) and/or step g) the size of an individual drop when applying the at least one varnish layer by means of printing is preferably selected from a range of from 2 pl to 50 pl, preferably is from 2.5 pl to 30 pl. It is further also possible for 2 to 10 drops, preferably 3 to 7 drops, to be combined during the arrangement.

It is also preferred that the dynamic viscosity of the varnish of the at least one varnish layer during the printing process is selected from a range of from 3 mPas to 100 mPas, preferably from 4 mPas to 80 mPas, preferably from 5 mPas to 50 mPas.

The resolution of the printhead is preferably between 300 npi and 1200 npi (npi=nozzles per inch). The resolution of the printing transverse to a feed direction of the substrate and/or of the printhead is thereby determined. The resolution along the feed direction of the substrate and/or of the printhead is determined by the accuracy of this feed using correspondingly accurately controlled drives and is preferably between 300 dpi and 4800 dpi.

It is further possible for the method further to comprise the following step, in particular which is carried out before step c) and/or step g):
h) pretreating the surface of the substrate and/or of the at least one film, in particular the decorative layer, in particular by means of one or more of the following methods: corona treatment, flame treatment, cleaning, plasma treatment.

Here, a better adhesion of the at least one film, in particular the decorative layer, or the at least one varnish layer to the substrate is achieved and a higher manufacturing quality is made possible.

It is also possible for the method to comprise the following further step, which in particular is carried out before and/or after step b) and/or step c):
i) forming the at least one film, in particular the decorative layer, and/or the substrate, preferably by means of vacuum or high pressure or deep-drawing dies.

Here, usual deep-drawing methods can be used in particular. As a rule, the at least one film, in particular decorative layer, and/or the substrate is provided in the form of sheets and placed in a deep-drawing die which has the desired final contour. Through the application of heat, preferably with a temperature of from 80° C. to 200° C., the at least one film, in particular decorative layer, and/or the substrate is made deformable. Now, the at least one film, in particular decorative layer, and/or the substrate can be adapted to the shape of the deep-drawing die by application of vacuum and/or by application of a form punch and/or positive air pressure and thus given the desired final contour. During cooling, the material of the film, in particular decorative layer, and/or the substrate then cures again, with the result that they retain the final contour.

After the deep-drawing, another mechanical post-processing may possibly be effected, for example by trimming, preferably mechanically or by means of lasers, milling, punching or the like.

In particular in step d) the varnish layer and/or the at least one film, in particular the decorative layer, is cured thermally and/or by high-energy radiation, preferably UV radiation. In particular, the curing is effected before and/or after the arrangement of the at least one film, in particular the decorative layer, on the substrate. For this, the apparatus according to the invention preferably has at least one UV lamp, in particular a mercury vapor lamp and/or UV LED lamp, and/or at least one IR heating element.

The curing in step d) is preferably effected by means of UV radiation with a radiation dose selected from the range of from 800 mJ/cm² to 1200 mJ/cm² and/or an intensity of at least 550 mW/cm² and/or at a wavelength in the range of from 200 nm to 280 nm. In particular, the at least one film, in particular the decorative layer, and/or the substrate has a different surface energy after step d) than they have during step c).

Naturally, depending on the field of application of the plastic article, it is in particular conceivable to place it in an injection mold in a further method step or a further method and to back-injection mold it with a plastic injection-molding material. It is further possible, beforehand and/or afterwards, to attach at least one functional element, in particular a backlighting apparatus, in particular comprising organic light-emitting diodes (OLEDs), inorganic light-emitting diodes (LEDs), micro-LEDs (mLEDs) and/or quantum-dot light-emitting diodes (QLEDs), and/or a touch-sensitive sensor (touch sensor) and/or further functional components, such as for example an electronic control system and/or mechanical and/or electrically conducting connection components and/or electromagnetic shields and/or thermal shields and/or optical shields. The functional element can be firmly joined to the plastic article, in particular by gluing or laminating. The functional element is preferably attached to the side of the plastic article facing away from the observer. Further, the functional element can additionally or alternatively have electrical lines and/or electrical/electronic components.

A plastic article according to the invention can in particular be shone through and is in particular used with a display and/or with a touchpad and/or with a panel. In particular, one of the following areas is particularly well suited to the use of the plastic article: white goods, motor vehicles, aviation, ships, household appliances, telecommunications devices, consumer goods, and/or electronic articles.

For the apparatus it can be advantageous if it further has supply rolls for the provision of the at least one film, in particular the decorative layer, and/or the substrate, conveying mechanisms for the at least one film, in particular the decorative layer, and/or the substrate, a roller arrangement for arranging for example adhesion promoters, a peeling unit for peeling a carrier film off at least one subarea of the transfer ply, a forming apparatus, an apparatus for pretreating the surface of the substrate and/or the film, in particular the decorative layer, an apparatus for the mechanical post-processing of the plastic article and the like, which is necessary in particular for carrying out the previously described method.

Of course, it is also possible to use, in an equivalent way, the above-cited characteristics in a method or the cited method features in the product.

### BRIEF DESCRIPTION OF THE DRAWINGS

The invention is explained by way of example below with reference to several embodiment examples with the help of the accompanying drawings. The embodiment examples shown are therefore not to be understood as limitative.

FIG. 1 shows a schematic sectional representation of a plastic article.

FIG. 2 shows a schematic sectional representation of a plastic article.

FIG. 3 shows a schematic sectional representation of a plastic article.

FIG. 4 shows a schematic sectional representation of a plastic article.

### DETAILED DESCRIPTION

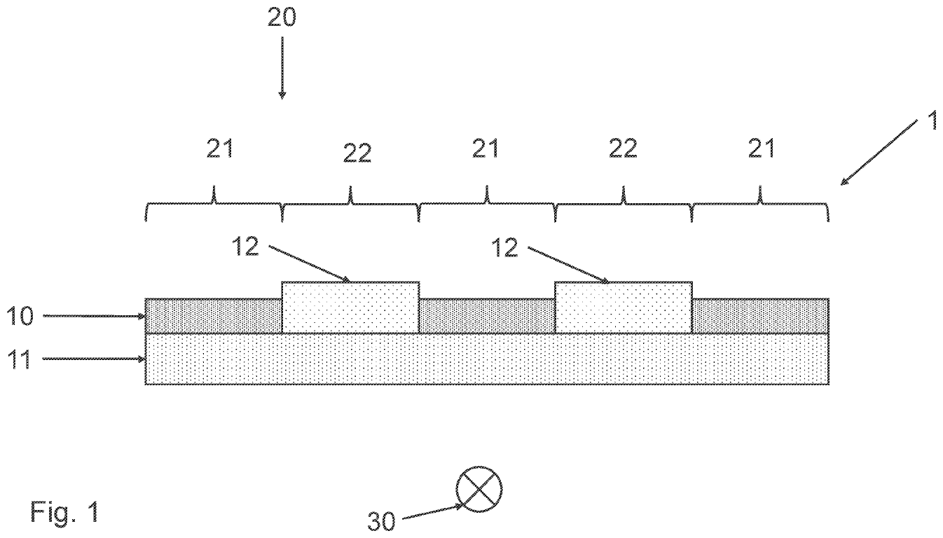

FIG. 1 shows a schematic sectional representation of a plastic article 1. The plastic article 1 comprises at least one film 10, in particular a decorative layer, and a substrate 11, and has at least one first area 21 and at least one second area 22. In the observation direction 20 of an observer, the plastic article 1 has the at least one film 10, in particular decorative layer, in the at least one first area 21 and at least one varnish layer 12 in the at least one second area 22. The at least one second area 22 has a higher transmittance than the at least one first area 21.

The plastic article 1 in FIG. 1 comprising the at least one first area 21 and the at least one second area 22 is obtained using a method, wherein in a preferred first step of the method (step a)) a film 10 comprising a carrier film and at least one decorative layer is provided. In a step b) the at least one first area 21 and the at least one second area 22 are introduced by means of lasers into the plane formed by the at least one film, in particular the decorative layer. Further, in a step c) at least one varnish layer 12 is arranged in at least one second area by means of digital printing. A further step, step d), of the production method is the curing, in particular the simultaneous curing, of the at least one film 10, in particular the decorative layer, and/or the at least one varnish layer 12. Further, the at least one film 10, in particular the decorative layer, is arranged on the substrate in a step e). It is in particular possible to carry out the method in the above order or in a different order.

The method for producing the plastic article is preferably carried out in an apparatus comprising at least one laser and at least one digital printhead.

It has proved to be advantageous that in step a) the at least one provided film 11, in particular the decorative layer, is preferably provided as a transfer film, in particular comprising a carrier film and a transfer ply detachable from the carrier film, or a laminating film, or is designed as a film of this type. It is possible for the carrier film to be peeled off during the method, in particular before, during or after step e).

The at least one film 11, in particular the decorative layer, is preferably a layer with components, in particular binders, selected individually or in combination from: monomers, oligomers, polymers, copolymers, preferably comprising, is selected individually or in combination from: polymethyl methacrylates, polyesters, polycarbonates, polyamides, polyurethanes, PVC, phenols, isocyanate-group-containing polymers, epoxide-group-containing polymers, melamine-containing polymers, hydroxyl-group-containing polymers, further preferably comprising polyurethanes and/or PVC.

It can further be advantageous if the at least one film 11, in particular the decorative layer, has layers, in particular has at least in each case one or more of the following layers, in each case selected individually or in combination from: at least one colored varnish layer, at least one metal layer, at least one adhesive layer, at least one adhesion-promoter layer, at least one barrier layer, at least one receiving layer, at least one protective varnish layer, at least one detachment layer, at least one replication layer, at least one laser protective varnish layer. It is further advantageous if the at least one decorative layer forms the transfer ply and is detachable from the carrier film.

The at least one film 11, in particular the decorative layer, preferably has a layer thickness selected from a range of from 0.1 μm to 50 μm, preferably from 0.5 μm to 35 μm, preferably from 1 μm to 5 μm.

The at least one film 11, in particular the decorative layer, can further have a metalization, in particular with a layer thickness of from 1 nm to 20 μm, preferably from 5 nm to 15 μm. The metalization is preferably formed of metals and/or metal combinations and/or alloys selected individually or in combination from: aluminum, copper, cobalt, gold, indium, iron, chromium, nickel, silver, platinum, palladium, titanium.

In the plastic article 1 shown in FIG. 1, the at least one film 11, in particular the decorative layer, is and/or has been arranged on the substrate 12 over the whole surface. Alternatively, the at least one film 11, in particular the decorative layer, can be or have been arranged only in areas, wherein in particular the substrate 12 is visible to an observer, in particular in the viewing direction onto the side of the substrate 12 facing the decorative layer.

It is advantageous in particular if the at least one film 11, in particular the decorative layer, is formed opaque and/or if the at least one film 11, in particular the decorative layer, has a transmittance, in particular in the wavelength range of from 380 nm to 780 nm, of at most 50%, preferably of at most 20%, further preferably of at most 5%.

It is possible for the at least one film 11, in particular the decorative layer, to be arranged in step e) using a transfer varnish method, in particular a hot-stamping method and/or an IMD method, and/or using a laminating method, in particular an IML method, an insert molding method and/or a PMD method.

Further, in the plastic article 1 shown in FIG. 1, the at least one film 11, in particular the decorative layer, is and/or has been arranged on the substrate 12 in such a way that the decorative layer 11 faces the observer.

The at least one film 11, in particular the decorative layer, is preferably arranged on the substrate 12 in such a way that it is firmly joined to the substrate 12, with the result that they can no longer be separated mechanically without damaging at least one of the elements.

In step b) the film, in particular the decorative layer, is irradiated by means of lasers in such a way that at least one first and one second area are formed, wherein the at least second area has a higher transmittance. In particular, it is advantageous if in step b) the at least one film 11, in particular the decorative layer, is and/or has been removed, preferably completely removed, in the at least one second area 22.

It is also possible for the at least one second area 22 to be formed in such a way that at least one of the layers of the decorative layer is removed. In particular, it is possible for the at least one second area 22 to be formed in such a way that at least one of the layers of the decorative layer, preferably at least one colored varnish layer, is not removed, preferably not completely removed, in the at least one second area 22. It is thus possible for at least one colored varnish layer to be arranged in the second area 22 in particular after step b).

Advantageously, the difference in the transmittance between the at least one first area 21 and the at least one second area 22 of the plastic article 1 is preferably at least 5%, preferably at least 10%, particularly preferably at least 25%, in particular in the wavelength range of from 380 nm to 780 nm. The at least one second area in the plastic article preferably has a higher transmittance than the at least one first area.

In particular, at least one second area 22 is and/or has been designed in the shape of or comprises a symbol, a geometric figure, a pattern, an alphanumeric character and/or a logo. These shapes can also be combined with abstract graphic design elements. The design of the at least one second area 22 can have a purely ornamental function, but preferably also be functional and, for example, mark display or operating elements of a device, such as status indicators, operating areas or the like.

It is further preferred if the at least one second area 22, when viewed perpendicular to the at least one film 10, in particular decorative layer, has a line width of at least 50 μm, preferably of at least 100 μm, and/or if the at least one second area 22, when viewed perpendicular to the at least one film 10, in particular decorative layer, has a line width of at most 2 mm, preferably of at most 1 mm, further preferably of at most 0.5 mm.

Advantageously, in step c) the at least one varnish layer 12 is and/or has been arranged in contact with the at least one film 10, in particular the decorative layer, and/or on the side of the substrate 11 facing away from the film 10, in particular the decorative layer.

In other words, in the plastic article in FIG. 1 the at least one varnish layer 12 is arranged on top of the substrate 11, in the observation direction 20, preferably on one of the surfaces of the substrate 11. Further, the at least one varnish layer is arranged in the area in which in step b) the at least one film, in particular the decorative layer, was removed, in particular completely removed, by irradiation by means of lasers.

It is possible for the varnish layer 12, in the at least one second area 22, in particular if in the at least one second area 22 at least one of the layers of the decorative layer is removed and/or at least one of the layers of the decorative layer, preferably at least one colored varnish layer, is not removed, preferably not completely removed, to overlap at least one of the layers of the decorative layer, preferably at least one colored varnish layer, over part of the surface or over the whole surface.

The at least one varnish layer 12 preferably has components which can be cured by exposure to thermal and/or high-energy radiation, preferably UV radiation, in particular with a wavelength in the range of from 200 nm to 280 nm. Expediently, in the plastic article 1 according to FIG. 1 the at least one varnish layer 12 is formed of components, in particular binders, selected individually or in combination from: polyethylene terephthalate (PET), polymethyl methacrylates, polyesters, polyacrylates, polycarbonates, polyethylene naphthalate (PEN), polyamides, acrylonitrile-butadiene-styrene copolymer (ABS), phenols, isocyanate-group-containing polymers, epoxide-group-containing polymers, melamine-containing polymers, hydroxyl-group-containing polymers.

It is also possible for the at least one varnish layer 12 to be dyed, in particular for the at least one varnish layer 12 to be dyed by means of dyes and/or color pigments. Preferably, the pigmentation level of the at least one varnish layer is less than 15%, preferably less than 10%, further preferably less than 5%.

However, it is also possible for the at least one varnish layer 12 to be colorless and/or to be clearly transparent and/or for the pigmentation level of the varnish layer to be 0%. The colored impression is determined here, for example, by a backlighting means arranged underneath the varnish layer.

The at least one second area 22 and/or the at least one varnish layer 12 is advantageously formed transparent and/or the at least second area 22 and/or the at least one varnish layer 12 have a transmittance, in particular in the wavelength range of from 380 nm to 780 nm, of at least 5%, preferably of at least 25%, further preferably of at least 75%, still further preferably of at least 90%.

In the at least one second area 22 the at least one varnish layer 12 can be arranged in one layer. It is further possible for the at least one varnish layer 12 to be formed of two or more partial layers, in particular wherein the partial layers have the same chemical and physical properties.

It is further possible for the at least one varnish layer to be and/or to have been arranged multilayered, in particular for the at least one varnish layer to be and/or to have been formed from two or more partial layers, wherein the two or more first partial layers are preferably arranged in each case with a layer thickness in the range of from 0.1 μm and 50 μm, further preferably of from 0.5 μm and 5.0 μm.

It further makes sense if the two or more partial layers have different colors, in particular from the RGB color space or the CMYK color space.

It is further conceivable that one of the colors of the partial layers of the at least one varnish layer is and/or has been arranged in areas, in particular that one of the colors is present in at least one first subarea and is not present in at least one second subarea and/or that the partial layers are and/or have been arranged in a grid, in particular selected from: frequency-modulated grid, amplitude-modulated grid, random grid, pseudo-random grid.

It is also possible for at least two differing varnish layers to be introduced in at least one of the second areas in step c), wherein the at least two varnish layers differ in particular in their optical properties, such as for example color and/or optical density and/or transmittance.

In other words, the at least one varnish layer 12 and/or the at least one second area 22 can be arranged and/or be designed in one color and/or multicolored.

It is further possible for the optical density of an at least second area 22 and/or at least one varnish layer, in particular in the case of a surface area completely covered with a single color shade, and/or of a subarea of at least one second area 22, to be selected from a range of from 0.5 to 3, preferably from 0.8 to 2.5 have.

Substantially, the at least one varnish layer preferably is and/or has been arranged only in the second area 22, but not in the first area 21.

It is possible for the at least one varnish layer 12 in FIG. 1 to be arranged register-accurately and/or registration-accurately.

The positionally accurate positioning can be effected in particular by means of sensory, preferably optically detectable registration marks or register marks, optical sensor units, preferably cameras, stencils, masks and/or mechanical limit stops. In particular, registration marks or register marks can either represent specific separate elements or areas or layers or themselves be part of the elements or areas or layers to be positioned.

The at least one varnish layer 12, which is arranged in such a way that it is arranged on top of the substrate 11 on the side of the plastic article 1 facing the observer, and/or is at least partially in contact with the at least one decorative layer 12, is preferably arranged with a tolerance of at most ±0.7 mm, preferably of at most ±0.5 mm, further preferably of at most ±0.3 mm, with respect to a target position or has the above tolerance with respect to a target position.

It is possible for the at least one varnish layer 12 to be arranged inline and/or downstream in step c). In other words, the method steps can be carried out directly one after another and/or the arrangement of the at least one varnish layer 12 is not effected until after the at least one film 10, in particular decorative layer, provided with the at least second area 22 has been, for example, temporarily stored, transported and/or removed from the apparatus provided for the method.

Advantageously, for carrying out the method for arranging the varnish layer 12, a varnish is used which has a surface energy during step c) preferably selected from a range of from 15 mN/m to 45 mN/m, preferably from 20 mN/m to 35 mN/m. It is further advantageous if the surface energy of the at least one film 10, in particular the decorative layer, and/or of the substrate 11 during step c) is selected from a range of from 30 mN/m to 50 mN/m, preferably from 30 mN/m to 45 mN/m.

The difference between the surface tension of the varnish of the at least one varnish layer and the at least one film, in particular the decorative layer, and/or the substrate is preferably at least a value selected from a range of from ±5 mN/m to ±100 mN/m, preferably from ±10 mN/m to ±70 mN/m and at most a value selected from a range of from ±15 mN/m to ±50 mN/m, preferably from ±20 mN/m to ±35 mN/m. The at least one film, in particular the decorative layer, and/or the substrate preferably has, during step c), a larger surface energy compared with the varnish to be deposited of the at least one varnish layer.

In the at least one second area 22 the at least one varnish layer 12 is preferably arranged with a layer thickness selected from a range of from 2 μm to 36 μm, preferably from 4 μm to 18 μm, preferably from 5 μm to 12 μm.

In particular, in FIG. 1 it would also be conceivable that alternatively or additionally no varnish layer 12 is and/or has been arranged in at least one second area 22, with the result that the substrate 11 forms the top layer in this area in the observation direction 20.

The substrate 11 is preferably formed single-layered or multilayered from thermoplastic materials selected individually or in combination from PC, PET, PMMA, PEN, PA, ABS.

The substrate 11 is advantageously formed transparent or semitransparent and/or the substrate 11 has a transmittance, in particular in the wavelength range of from 380 nm to 780 nm, of at least 10%, preferably of at least 25%, further preferably of at least 75%, still further preferably of at least 90%.

It is further possible for the method further to comprise the following step, in particular which is carried out before step c) and/or step g):
h) pretreating the surface of the substrate 11 and/or of the at least one film 10, in particular the decorative layer, in particular by means of one or more of the following methods: corona treatment, flame treatment, cleaning, plasma treatment.

The substrate 11 preferably has a layer thickness selected from a range of from 0.25 mm to 20 mm, in particular from 1 mm to 5 mm.

Advantageously, the at least one laser used during the method in step b) and/or present in the apparatus is preferably selected from: solid-state laser, preferably fiber laser, YAG laser, UV laser, ruby laser and/or sapphire laser, diode laser, gas laser and/or dye laser.

It is also advantageous that the at least one laser preferably emits coherent light from the infrared range, in particular from the near infrared range, further preferably from the wavelength range of from 200 nm to 1400 nm, preferably from 780 nm to 1200 nm, further preferably light with a wavelength of 1064 nm. Alternatively, a laser can also be used which in particular emits coherent light from the UV range, further preferably with a wavelength of from 340 nm to 400 nm, further preferably light with a wavelength of 355 nm. The laser can further be operated continuously or pulsed.

It is further also possible for the at least one laser to be used with a beam diameter at the focal point of at least 30 μm, preferably at least 50 μm, preferably at least 100 μm, in step b).

It is also possible to focus the laser beam by means of at least one lens, in particular with a focal length in a range of from 100 mm to 500 mm, preferably from 150 mm to 300 mm, further preferably of 163 mm or 254 mm.

It is expedient if the laser beam is deflected by means of movable mirrors, in particular by means of a laser scanning module, along the at least one second area 22 in step b).

The laser beam can in particular be controlled with a tolerance of at most ±0.5 mm, preferably of at most ±0.3 mm, further preferably of at most ±0.1 mm, with respect to a target position or the second area 22 thus generated by means of lasers has a tolerance of at most ±0.5 mm, preferably of at most ±0.3 mm, further preferably of at most ±0.1 mm, with respect to a target position.

The at least one laser preferably has a power selected from a range of from 0.05 W to 100 W, preferably from 1 W to 50 W, further preferably from 5 W to 20 W. In particular, the at least one laser is operated with a writing speed of at most 10,000 mm/s, preferably with a writing speed selected from a range of from 500 m/s to 2500 mm/s.

The at least one laser is further operated in particular with a pulse frequency selected from a range of from 1 Hz to 1000 kHz, preferably from 25 kHz and 400 kHz, and/or the at least one laser is operated with up to 3000 characters/s, preferably selected from a range of from 800 characters/s to 1500 characters/s. The required intensity of the laser beam conforms to the type and thickness of the at least one film 10, in particular the decorative layer, and also to the speed with which the at least one film 10, in particular the decorative layer, is to be removed.

In step c) one of the following digital printing methods is preferably used, in particular for the arrangement of the at least one varnish layer 12: inkjet, in particular continuous inkjet and/or piezoelectric inkjet and/or thermoelectric inkjet (bubble jet), and/or thermal printing.

For producing the plastic article 1 according to FIG. 1, in step c) the size of an individual drop when arranging the at least one varnish layer 12 by means of printing is preferably selected from a range of from 2 pl to 50 pl, preferably from 2.5 pl to pl. It is further also possible for 2 to 10 drops, preferably 3 to 7 drops, to be combined during the arrangement.

It is also preferred that in step c) the dynamic viscosity of the varnish of the at least one varnish layer 12 during the printing process is selected from a range of from 3 mPas to 100 mPas, preferably from 4 mPas to 80 mPas, preferably from 5 mPas to 50 mPas.

The resolution of the printhead in step c) is preferably between 300 and 1200 npi (npi=nozzles per inch). The resolution of the printing transverse to a feed direction of the substrate and/or of the printhead is determined thereby. The resolution along the feed direction of the substrate and/or of the printhead is determined by the accuracy of this feed using correspondingly accurately controlled drives and is preferably between 300 dpi and 4800 dpi.

It is also possible for the method to comprise the following further step, which in particular is carried out before and/or after step b) and/or step c):
i) forming the at least one film 10, in particular the decorative layer, and/or the substrate (11), preferably by means of vacuum or high pressure or deep-drawing dies.

Here, usual deep-drawing methods can be used in particular. As a rule, the at least one film 10, in particular decorative layer, and/or the substrate 12 is provided in the form of sheets and placed in a deep-drawing die which has the desired final contour. Through the application of heat, preferably with a temperature of from 80° C. to 200° C., the at least one film 10, in particular decorative layer, and/or the substrate 11 is made deformable. Now, the at least one film 10, in particular the decorative layer, and/or the substrate can be adapted to the shape of the deep-drawing die by application of vacuum and/or by application of a form punch and/or positive air pressure and thus given the desired final contour. During cooling, the material of the film 10, in particular the decorative layer, and/or the substrate 11 then cure again, with the result that they retain the final contour.

After the deep-drawing, another mechanical post-processing may possibly be effected, for example by trimming, preferably mechanically or by means of lasers or milling or punching or the like.

In particular, in step d) the varnish layer 12 and/or the at least one film 10, in particular the decorative layer, is cured thermally and/or by high-energy radiation, preferably UV radiation. In particular, the curing is effected before and/or after the arrangement of the at least one film 10, in particular the decorative layer, on the substrate 11. For this, the apparatus according to the invention preferably has at least one UV lamp, in particular a mercury vapor lamp and/or UV LED lamp, and/or at least one IR heating element.

The curing in step d) is preferably effected by means of UV radiation with a radiation dose selected from the range of from 800 mJ/cm² to 1200 mJ/cm² and/or an intensity of at least 550 mW/cm² and/or at a wavelength in the range of from 200 nm to 280 nm. In particular, the at least one film 10, in particular the decorative layer, and/or the substrate 11 has a different surface energy after step d) than they have during step c).

Naturally, depending on the field of application of the plastic article 1, it is in particular conceivable to place it in an injection mold in a further method step or a further method and to back-injection mold it with a plastic injection-molding material. It is further possible, beforehand and/or afterwards, to attach at least one functional element, in particular a backlighting apparatus 30, in particular comprising organic light-emitting diodes (OLEDs), inorganic light-emitting diodes (LEDs), micro-LEDs (mLEDs) and/or quantum-dot light-emitting diodes (QLEDs), and/or a touch-sensitive sensor (touch sensor) and/or further functional components, such as for example an electronic control system and/or mechanical and/or electrically conducting connection components and/or electromagnetic shields and/or thermal shields and/or optical shields. The functional element can be firmly joined to the plastic article 1, in particular by gluing or laminating. The functional element is preferably attached to the side of the plastic article 1 facing away in the observation direction 20. Further, the functional element can additionally or alternatively have electrical lines and/or electrical/electronic components.

The plastic article 1 according to the invention in FIG. 1 can be used with a display and/or with a touchpad and/or with a panel, for example. In particular, one of the following areas has proved for the use of the plastic article 1: white goods, motor vehicles, aviation, ships, household appliances, telecommunications devices, consumer goods, and/or electronic articles.

For the apparatus it can be advantageous if it further has supply rolls for the provision of the at least one film 10, in particular the decorative layer, and/or the substrate 11, conveying mechanisms for the at least one film 10, in particular the decorative layer, and/or the substrate, a roller arrangement for arranging for example adhesion promoters, a peeling unit for peeling a carrier film off at least one subarea of the transfer ply, a forming apparatus, an apparatus for pretreating the surface of the substrate 11 and/or the film 10, in particular the decorative layer, an apparatus for the mechanical post-processing of the plastic article 1 and the like, which is necessary in particular for carrying out the previously described method.

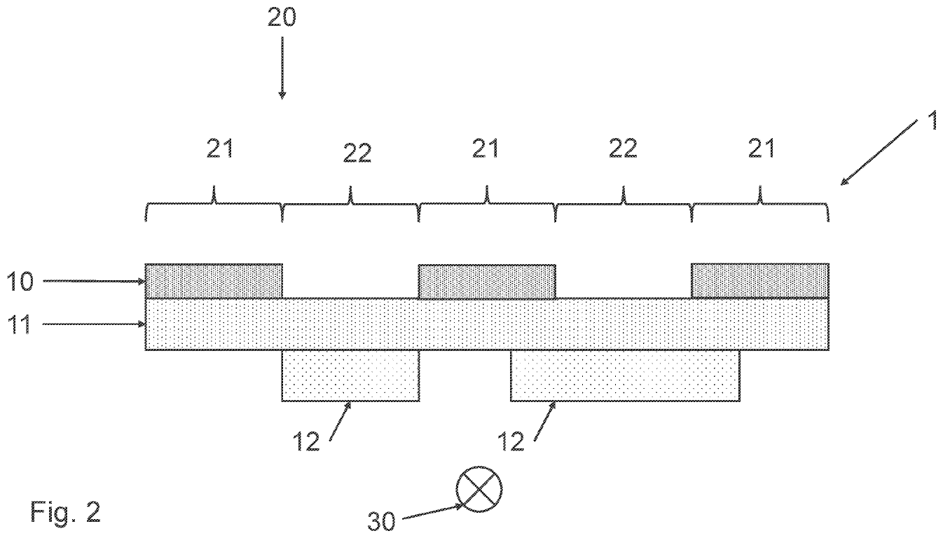

FIG. 2 shows a schematic sectional representation of a further plastic article 1. The plastic article 1 in FIG. 2 is substantially based on the structure of the plastic article 1 and the method for producing the plastic article 1 according to FIG. 1.

Thus, the plastic article 1 in FIG. 2 also has a substrate 11 and at least one film 10, in particular a decorative layer. In the observation direction 20 onto the plane formed by the substrate 11, the plastic article 1 at least likewise comprises at least one first area 21 and at least one second area 21. The plastic article 1 can also be shone through, in particular can be shone through with a backlighting apparatus 30.

Further, the method for producing the plastic article 1 can be carried out in the same apparatus as for producing the plastic article 1 in FIG. 1.

The important difference from the plastic article 1 according to FIG. 1 is that the at least one varnish layer 12 is arranged on the side of the substrate 11 facing away in the observation direction 20. In other words, the at least one varnish layer 12 is arranged underneath the substrate 11 in the observation direction 20.

The at least one varnish layer 12 arranged in at least one second area 22 can further be arranged substantially only in at least one second area 22 and not in the adjoining first areas 21. It is further also possible for the at least one varnish layer 12 arranged in at least one second area 22 to be and/or have been arranged overlapping at least one of the first areas 21 in areas in step c).

The at least one varnish layer 12, which is arranged on the side of the substrate 11 facing away from the at least one film 10, in particular decorative layer, is preferably arranged with a tolerance of at most ±5 mm, preferably of at most ±1 mm, further preferably of at most ±0.3 mm, with respect to a target position and/or has the above tolerance with respect to a target position. Compared with printing on top of the substrate, lower tolerances can be adhered to as the second areas act like masks in the case of an observation from above onto the second areas.

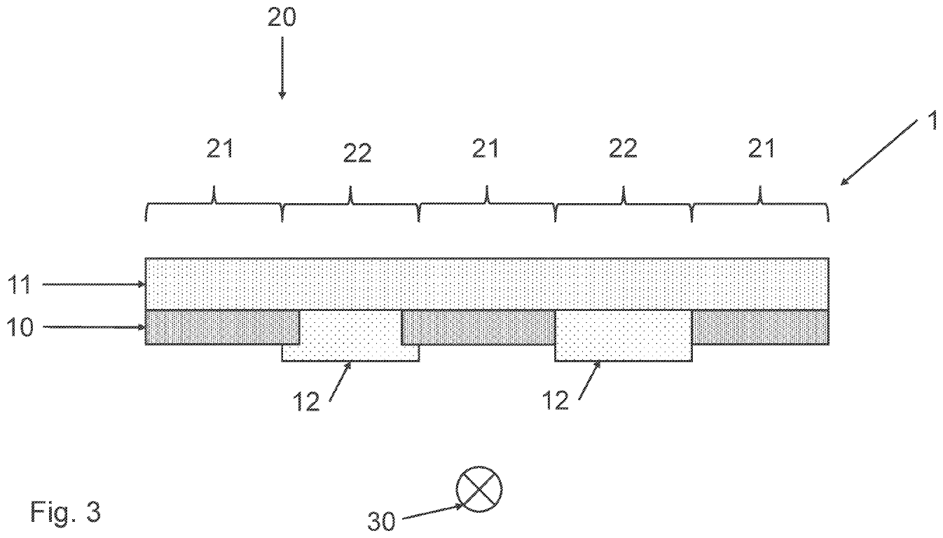

A schematic sectional representation of a further plastic article 1 is shown in FIG. 3. The plastic article 1 in FIG. 3 is substantially based on the structure of the plastic article 1 and the method for producing the plastic article 1 according to FIG. 1 and/or FIG. 2.

The plastic article 1 in FIG. 3 also has a substrate 11 and at least one film 10, in particular decorative layer. In the observation direction 20 onto the plane formed by the substrate 11, the plastic article 1 further likewise comprises at least one first area 21 and at least one second area 22 and can be shone through, in particular can be shone through using a backlighting apparatus 30.

The method for producing the plastic article 1 can be carried out in the same apparatus as the method for producing the plastic article 1 according to FIG. 1.

The plastic article 1 according to FIG. 3 substantially differs from the plastic articles 1 according to FIG. 1 and/or FIG. 2 in that the at least one film 10, in particular the decorative layer, and the at least varnish layer 12 arranged in the second areas 22 is attached underneath the substrate 11 in the observation direction. Here, the at least one varnish layer 12 can be and/or have been arranged substantially only at least one second area 22 and/or arranged overlapping at least one first area 21.

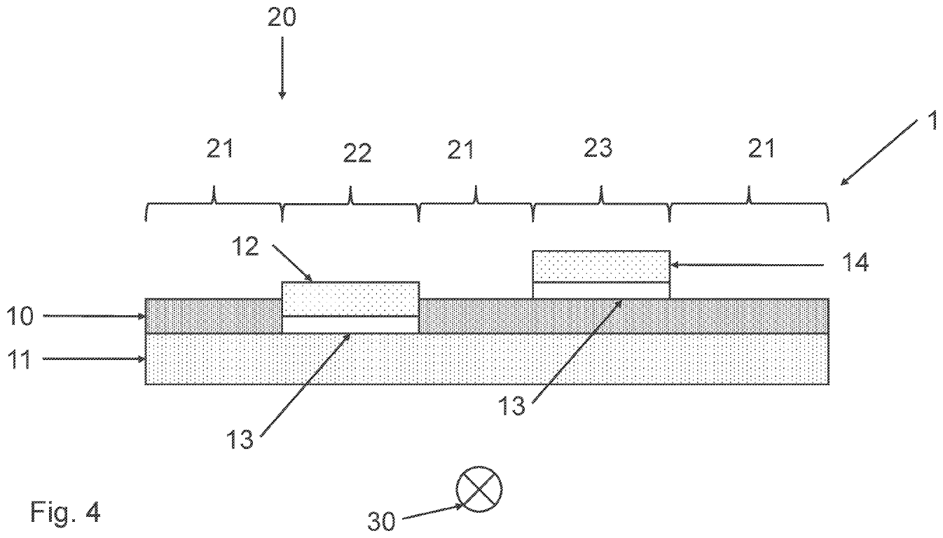

FIG. 4 shows a schematic sectional representation of a plastic article 1. The plastic article 1 can preferably be produced by means of the method and/or apparatus described with respect to FIG. 1, 2 or 3. The plastic article 1 shown in FIG. 4 is based in particular on the plastic article 1 according to FIG. 1 presented above. It also comprises a substrate 11 and at least one film 10, in particular decorative layer, arranged on top of the substrate 11 in the observation direction 20. In the observation direction 20 onto the plane formed by the substrate, the plastic article 1 has at least one first area 21 and at least one second area 22 introduced by means of lasers. At least one varnish layer 12 is and/or has been arranged in the at least one second area 22.

It is also possible for a primer 13 to be arranged in at least one second area 22 before the at least one varnish layer 12 is arranged. In particular, the primer 13 is arranged between the substrate 11 and/or the at least one film 10, in particular the decorative layer, and the at least one varnish layer 12.

The primer 13 preferably has a transmittance, in particular in the wavelength range of from 380 nm to 780 nm, of at least 10%, preferably of at least 25%, further preferably of at least 75%, still further preferably of at least 90%. It is also possible for the primer 13 to be dyed, preferably to be dyed white, in particular for the primer 13 to be dyed by means of dyes and/or color pigments. Preferably, the pigmentation level of the primer 13 is less than 15%, preferably less than 10%, further preferably less than 5%.

However, it is also possible for the primer 13 to be colorless and/or to be clearly transparent and/or for the pigmentation level of the primer 13 to be 0%.

The primer 13 is preferably arranged with a layer thickness selected from a range of from 0.1 μm to 10 μm, preferably from 0.3 μm to 5 μm.

The at least one film 10, in particular the decorative layer, can further be overprinted and the method for producing a plastic article according to FIG. 3 further comprises the following step, in particular which is carried out before step d) and/or before and/or after step c):
g) printing on the at least one film 10, in particular the decorative layer, by means of digital printing, in particular with a primer 13 and/or with at least one varnish layer 12, preferably comprising a haptic varnish, wherein at least one third area 23 is formed, and wherein the at least one third area 23 does not overlap the at least one second area 22.

For a design of the at least one third area 23 in FIG. 4 it is preferably possible to fall back on the design variants of the at least one second area 22 mentioned above, in particular with regard to the printing methods and/or the printing parameters and/or the printing apparatuses.

Alternatively or additionally, the at least one third area 23 can be formed opaque and/or have a remission, in particular in the wavelength range of from 380 nm to 780 nm, of at most 0.5, preferably of at most 0.2, further preferably of at most 0.05.

For example, for arranging the at least one third area 23 the same printhead can be used which is also used for arranging the at least second area 22. The printing can thus can be carried out in particular inline in step g). Alternatively, step g) can also be carried out downstream. In particular, it is advantageous to arrange the at least one third area 23 where no backlighting means 30 are attached. The at least one first area 21 and the at least one third area 23 preferably overlap at least in areas and/or completely.

Of course, the mentioned embodiment variants, in particular with respect to the first, second and third areas and/or the method steps or the orders thereof, can be combined with each other as desired and do not represent a limitation.

### LIST OF REFERENCE NUMBERS

1 plastic article
10 film, decorative layer
11 substrate
12 varnish layer
13 primer
14 varnish layer
20 observation direction
21 first area
22 second area
23 third area
30 backlighting means

1. A method for producing a plastic article, comprising:
a) providing at least one film comprising a carrier film and at least one decorative layer,
b) forming, by means of a laser, at least one first area and at least one second area in the plane formed by the at least one film, wherein the at least one second area has a higher transmittance than the at least first area,
c) arranging at least one varnish layer in the at least one second area by means of digital printing,
d) curing, the at least one film, and/or the at least one varnish layer,
e) arranging the at least one film, on a substrate,
f) obtaining a plastic article comprising the at least one first area and the at least one second area.

2. The method according to claim 1, wherein,
in step a) the at least one film is provided as a transfer film or laminating film.

3. The method according to claim 1, wherein
in step b) the at least one film, is removed, in the at least one second area.

4. The method according to claim 1, wherein
in step b) the at least one laser is operated with a writing speed of at most 10,000 mm/s, and/or wherein the at least one laser is operated with a pulse frequency selected from the range of from 1 Hz to 1000 kHz, with up to 3000 characters.

5. The method according to claim 1, wherein
at least one second area is designed in the shape of or comprises a symbol, a geometric figure, a pattern, an alphanumeric character and/or a logo.

6. The method according to claim 1, wherein
the at least one laser is operated continuously or pulsed.

7. The method according to claim 1, wherein
a primer is arranged in at least one second area, before the at least one varnish layer is arranged.

8. The method according to claim 1, wherein
the method further comprises the following step:
g) printing on the at least one film, by means of digital printi, wherein at least one third area is formed, and wherein the at least one third area does not overlap the at least one second area.

9. The method according to claim 1, wherein
step c) and/or step g) are carried out inline and/or downstream.

10. The method according to claim 1, wherein
in step c) one of the following digital printing methods is used: inkjet, and/or thermal printing.

11. The method according to claim 1, wherein
in step c) the at least one varnish layer is arranged in contact with the at least one film, and/or is arranged on the side of the substrate facing away from the film.

12. The method according to claim 1, wherein
in step c) the at least one varnish layer is arranged at least partially overlapping the at least one first area.

13. The method according to claim 1, wherein
at least two differing varnish layers are introduced in at least one second area in step c).

14. The method according to claim 1, wherein
no varnish layer is arranged in at least one second area.

15. The method according to claim 1, wherein
in at least one second area the at least one varnish layer is arranged with a layer thickness selected from a range of from 2 μm to 36 μm.

16. The method according to claim 1, wherein
in at least one second area at least one varnish layer is formed in one layer or wherein the at least one varnish layer is formed of two or more partial layers.

17. The method according to claim 16, wherein
the two or more partial layers of at least one varnish layer have different colors, and/or wherein one of the colors of the partial layers of at least one varnish layer is arranged in areas, and/or wherein the partial layers are arranged in a grid.

18. The method according to claim 1, wherein
the at least one varnish layer is arranged register-accurately and/or registration-accurately.

19. The method according to claim 1, wherein
the at least one varnish layer, which is arranged in such a way that it is arranged on top of the substrate on the side of the plastic article facing the observer, and/or is at least partially in contact with the at least one film.

20. The method according to claim 1, wherein
the optical density of at least one second area and/or of at least one varnish lay, and/or of a subarea of at least one second area, is selected from a range of from 0.5 to 3.

21. The method according to claim 1, wherein
in step c) a varnish is used which has a surface energy selected from a range of from 15 mN/m to 45 mN/m, and/or wherein the surface energy of the at least one film, and/or of the substrate is selected from a range of from 30 mN/m to 50 mN/m.

22. The method according to claim 1, wherein
in step c) and/or step g) the size of an individual drop when arranging the at least one varnish layer by means of printing is selected from a range of from 2 pl to 50 pl, and/or wherein 2 to 10 drops, are combined during the arrangement.

23. The method according to claim 1, wherein
in step c) and/or step g) the dynamic viscosity of the varnish of the at least one varnish layer during the printing process is selected from a range of from 3 mPas to 100 mPas.

24. The method according to claim 1, wherein
in step c) and/or step g) the resolution of a printhead is between 300 npi and 1200 npi.

25. The method according to claim 1, wherein
the at least one film, is arranged on the substrate over the whole surface in step e).

26. The method according to claim 1, wherein
in step e) the at least one film, is arranged on the substrate using a transfer varnish metd, and/or using a laminating method.

27. The method according to claim 1, wherein
in step e) the at least one film, is arranged on the substrate in areas.

28. The method according to claim 1, wherein
the method further comprises the following step:
h) pretreating the surface of the substrate and/or of the at least one film.

29. The method according to claim 1, wherein
the method comprises the further step:
i) forming the at least one film, and/or the substrate.

30. The method according to claim 1, wherein
in step d) the at least one varnish layer and/or the at least one film is cured thermally and/or by high-energy radiation.

31. The method according to claim 1, wherein
the curing in step d) is effected by means of UV radiation with a radiation dose selected from the range of from 800 mJ/cm² to 1200 mJ/cm² and/or an intensity of at least 550 mW/cm² and/or at a wavelength of from 200 nm to 280 nm.
